(19) United States
(12) Patent Application Publication
(10) Pub. No.: US 2026/0212832 A1
(43) Pub. Date: Jul. 23, 2026

(54) DISPLAY PANEL AND DISPLAY DRIVER Configured to Generate Compensation Signals According to Detected Display Temperature

(71) Applicant: NOVATEK Microelectronics Corp., Hsinchu (TW)

(72) Inventor: Chun-Hung CHEN, Yunlin County (TW)

(21) Appl. No.: 19/216,750

(22) Filed: May 23, 2025

(30) Foreign Application Priority Data
Jan. 23, 2025 (TW) 114103136

(51) Int. Cl. G09G 3/34

(52) U.S. Cl. CPC G09G 3/3426; G09G 2320/0271; G09G 2320/041

(57) ABSTRACT

A display panel comprising a display circuit, a conductive circuit, a plurality of sensing circuits and a display driver. The conductive circuit is configured to provide power to the display circuit. The plurality of sensing circuits are arranged at a plurality of positions in the display panel corresponding to the display circuit. The plurality of sensing circuits and the conductive circuit are formed by a same material. The display driver is coupled to the display circuit, the conductive circuit and the plurality of sensing circuits, and is configured to detect a plurality of sensing impedances of the plurality of sensing circuits to generate a plurality of compensation signals. The display driver is configured to control the display circuit according to the plurality of compensation signals.

### CROSS-REFERENCE TO RELATED APPLICATION

This application claims priority to Taiwan Application Serial Number 114103136, filed Jan. 23, 2025, which is herein incorporated by reference in its entirety.

### BACKGROUND

### Technical Field

The present disclosure relates to display technology, and more particularly to a display panel and a display driver.

### Description of Related Art

With the rapid development of electronic technology, display panels have been widely used in daily life, such as smart phones and computers. The display panel controls the brightness of each pixel according to the image signal to present the corresponding image. However, due to non-ideal factors such as temperature, transmission delay or component performance differences, the driving signal of the display panel needs to be compensated accordingly, and the compensation technology will directly affect the performance and quality of the display panel.

### SUMMARY

One aspect of the present disclosure is a display panel, comprising a display circuit, a conductive circuit, a plurality of sensing circuits and a display driver. The conductive circuit is configured to provide power to the display circuit. The plurality of sensing circuits are arranged at a plurality of positions in the display panel corresponding to the display circuit. The plurality of sensing circuits and the conductive circuit are formed by a same material. The display driver is coupled to the display circuit, the conductive circuit and the plurality of sensing circuits, and is configured to detect a plurality of sensing impedances of the plurality of sensing circuits to generate a plurality of compensation signals. The display driver is configured to control the display circuit according to the plurality of compensation signals.

Another aspect of the present disclosure is a display driver, comprising a detection circuit, a conversion circuit and a compensation circuit. The detection circuit is coupled to a plurality of sensing circuits of a display panel, and is configured to detect a plurality of sensing impedances of the plurality of sensing circuits. The plurality of sensing circuits and a conductive circuit of the display panel are formed by a same material, and the conductive circuit is configured to provide power to a display circuit of the display panel. The conversion circuit is coupled to the detection circuit, and is configured to calculate a plurality of detected temperature values according to the plurality of sensing impedances. The compensation circuit is coupled to the conversion circuit and the display circuit, and is configured to generate a plurality of compensation signals according to the plurality of detected temperature values, so as to control the display circuit according to the plurality of compensation signals.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a display panel in some embodiments of the present disclosure.

FIG. 2 is a schematic diagram of a display driver in some embodiments of the present disclosure.

FIG. 3A is a schematic diagram of a display panel in some embodiments of the present disclosure.

FIG. 3B is a schematic diagram of a detection unit in some embodiments of the present disclosure.

FIG. 4A is a schematic diagram of a display panel in some embodiments of the present disclosure.

FIG. 4B is a schematic diagram of a detection unit in some embodiments of the present disclosure.

FIG. 4C is a partial enlarged schematic diagram of the display panel in some embodiments of the present disclosure.

FIG. 5 is a schematic diagram of a partial circuit of the display panel in some embodiments of the present disclosure.

FIG. 6 is a schematic diagram of a partial circuit of a display panel in some embodiments of the present disclosure.

FIG. 7 is a schematic diagram of a gamma curve in some embodiments of the present disclosure.

### DETAILED DESCRIPTION

For the embodiment below is described in detail with the accompanying drawings, embodiments are not provided to limit the scope of the present disclosure. Moreover, the operation of the described structure is not for limiting the order of implementation. Any device with equivalent functions that is produced from a structure formed by a recombination of elements is all covered by the scope of the present disclosure. Drawings are for the purpose of illustration only, and not plotted in accordance with the original size.

It will be understood that when an element is referred to as being “connected to” or “coupled to”, it can be directly connected or coupled to the other element or intervening elements may be present. In contrast, when an element to another element is referred to as being “directly connected” or “directly coupled,” there are no intervening elements present. As used herein, the term “and/or” includes associated listed items or any and all combinations of more.

With the advancement of display technology, high-speed operation of display panels is increasingly being used, and electronic components within display panels are also being continuously improved to increase operation and response speed. However, with the advancement of electronic components, the sensitivity of electronic components to temperature has also increased. In order to avoid different areas of the display panel having different temperatures, causing the uniformity of the display to be affected, the display panel can sense the temperature of different areas and compensate the image according to the sensing result.

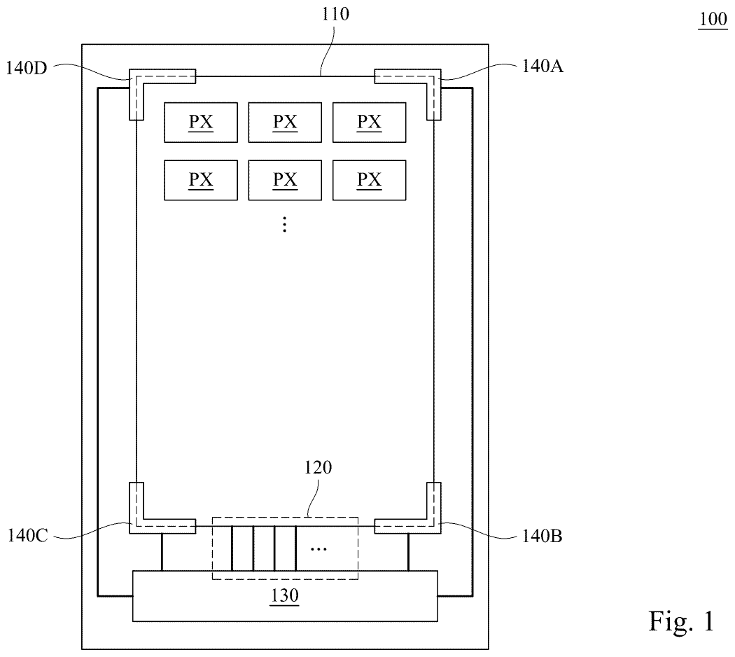

FIG. 1 is a schematic diagram of a display panel 100 in some embodiments of the present disclosure. The display panel 100 includes a display circuit 110, a conductive circuit 120, a display driver 130 and a sensing circuits 140A-140D. The display circuit 110 includes multiple pixel units PX to display the image screen. In one embodiment, the display circuit 110 can be a Liquid-Crystal Display (LCD), such as thin film transistor liquid crystal display (TFT-LCD). In other embodiments, the display circuit 110 can be an Organic Light Emitting Diode (OLED) or other types of the display circuit. Since those skilled in the art can understand the internal structure and driving principle of the display circuit, it will not be described here in detail.

The display driver 130 is coupled to the conductive circuit 120 and the sensing circuits 140A-140D, and is configured to provide power and driving signal to the display circuit 110 through the conductive circuit 120. The sensing circuits 140A-140D are arranged at the positions in the display panel 100 corresponding to the display circuit 110, such as the positions corresponding to the edge(s) of the display circuit 110, or partially overlaps with the display circuit 110. The sensing circuits 140A-140D is configured to sence/detect the temperature or temperature change at different positions on the display panel 100, and the display driver 130 compensates the driving signal to be transmitted to the display circuit 110 according to the temperature or the temperature change.

In this embodiment, the conductive circuit 120 and the sensing circuits 140A-140D are formed by a same material, such as Indium Tin Oxide (ITO). The Indium Tin Oxide has a special material property: the impedance value chang has a predictable and specific relationship with the temperature chang. Therefore, the display driver 130 can estimate the temperature change by measuring the impedance value change. In one embodiment, the display driver 130 obtains the impedance change or voltage change according to the sensing circuits 140A-140D, calculates the temperature change or temperature change value, and then calculates the compensation signal by looking up a table or a preset characteristic formula.

For example, the display driver 130 adjust the driving voltage provided to the display circuit 110 according to the compensation signal, so as to control the display circuit. Furthermore, the display driver 130 provides different driving voltages according to the pixel units PX in different regions of the display circuit 110. In other embodiments, the display driver 130 adjusts the pixel value or or grayscale value of the image signal according to the compensation signal.

The present disclosure utilizes the thermal sensitivity of the sensing circuits 140A-140D in the display panel 100 to perform temperature sensing. By utilizing the characteristic relationship between impedance and temperature, arranging the sensing circuits 140A-140D in different regions of the display panel 10, so that the display driver 130 can sence/detect temperature changes at different postions.

The number and positions of the sensing circuits 140A-140D may be adjusted according to requirements. In one embodiment, the sensing circuits 140A-140D are arranged at multiple positions in the display panel 100 corresponding to the edge(s) of the display circuit 110, such as positions adjacent to the four corners of the display circuit 110. According to the multiple positions where the sensing circuits 140A-140D are arranged, the display driver 130 can divide the display circuit 110 into multiple regions to perform compensation respectively. For example, the sensing circuits 140A-140D are arranged at four corners of the display circuit 110, so that the display panel 100 can be divided into at least four regions. The display driver 130 determines the temperatures of different regions according to the sensing circuits 140A-140D, and generates different compensation signals.

In some embodiments, there is at least one part of each of the sensing circuits 140A-140D arranges in an active area of the display panel 100. The active area is an area of the display panel 100 used to display the image screen. The area that the display circuit 110 labeled in FIG. 1 can be regarded as the active area. In other embodiments, the sensing circuits 140A-140D may also be completely arranged in the active area, or completely arranged outside the active area.

In some embodiments, the display driver 130 can divide the display circuit 110 into multiple regions, the number of regions is greater than the number of sensing circuits, for example, divided into 25 regions, wherein each region of the four corners corresponds to one of the sensing circuits. The following table shows that the active area of the display panel is divided into multiple regions. The table includes 25 columns X11-X15, X21-X25, X31-X35, X41-X45 and X51-X55, each column represents an region.

| | | | | |
|---|---|---|---|---|
| X11 | X12 | X13 | X14 | X15 |
| X21 | X22 | X23 | X24 | X25 |
| X31 | X32 | X330 | X34 | X35 |
| X41 | X42 | X43 | X44 | X45 |
| X51 | X52 | X53 | X54 | X55 |

Please refer to the table above and refer to FIG. 1. The sensing circuits 140A-140D are arranged at four corners of the active area, so the display driver 130 can calculate the temperatures of the four regions X11, X15, X51, and X54 according to the sensing impedances of the sensing circuits 140A-140D. The display driver 130 can calculate the temperatures of other regions by interpolation to accurately compensate each region to varying degrees. Since those skilled in the art can understand the operation method of interpolation, it will not be described here in detail.

In some embodiments, each of the sensing circuits 140A-140D includes a L-shaped pattern structure (FIG. 1 is only a simplified schematic diagram, and the specific embodiments will be described in the subsequent paragraphs and diagrams.). The L-shaped pattern structure is arranged in the active area of the display panel 100.

As mentioned above, the present disclosure utilizes the material property of the sensing circuits 140A-140D of the display panel 100 to sence/detect temperatures. The sensing circuits 140A-140D and the conductive circuit 120 can be laid out in the same process, and the sensing circuits 140A-140D do not need to be connected to the display circuit 110, but the sensing circuits 140A-140D can be formed/arranged at different positions in the display panel 100 to accurately detect the temperatures so that the compensation of the display driver 130 can be more accurate.

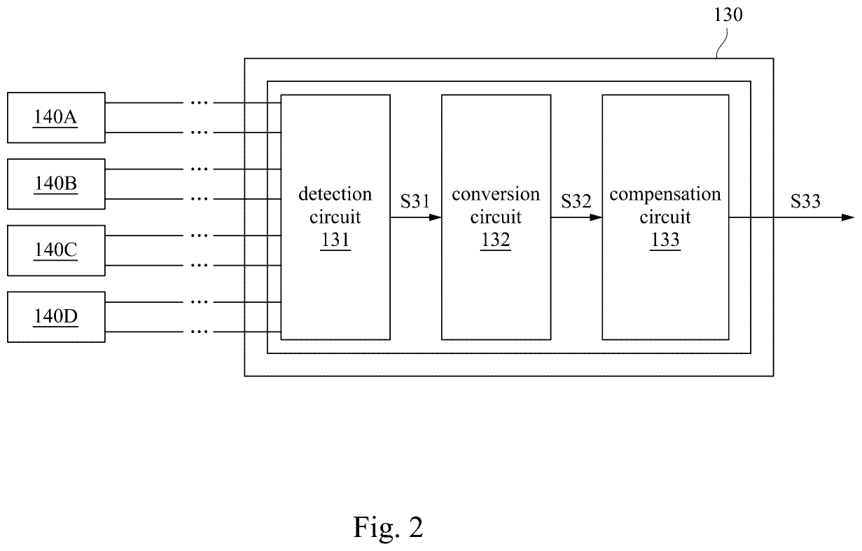

FIG. 2 is a schematic diagram of a display driver 130 in some embodiments of the present disclosure. In some embodiments, the display driver 130 includes a detection circuit 131, a conversion circuit 132 and a compensation circuit 133. The detection circuit 131 is coupled to the sensing circuits 140A-140D, and is configured to detect/sence the sensing impedance of each of the sensing circuits 140A-140D, and generate the impedance signal S31.

The conversion circuit 132 is coupled to the detection circuit 131 to receive the impedance signal S31. The conversion circuit 132 is configured to calculate the corresponding detected temperature value (e.g., 60 degrees Celsius) according to the sensing impedance detected by the detection circuit 131, so as to generate the temperature signal S32. In one embodiment, the conversion circuit 132 stores the characteristic data between temperature and impedance of each of the sensing circuits 140A-140D so that the detected temperature value can be calculated by calculation or table lookup.

The compensation circuit 133 is coupled to the conversion circuit 132 and the display circuit 110, and is configured to generate the corresponding compensation signal S33 according to the detected temperature value calculated by the conversion circuit 132, and control the display circuit 110 according to the compensation signal S33. For example, when determining that the temperature increases, causing the brightness of the pixel units PX to become more obvious, the compensation circuit 133 can generate the compensation signal S33 to decrease the brightness in response to the temperature change. This “driving signal adjusted according to the temperature change” is the compensation signal, and can be used to adjust/update the original driving signal. In one embodiment, the compensation circuit 133 adjusts the gamma value applied by the display panel 100, a pixel driving signal or a duty cycle of a backlight control signal according to the compensation signal S33, and the details will be described in subsequent paragraphs.

In some embodiments, the display driver 130 further includes a driving circuit (not shown in figure), the driving circuit is coupled to the compensation circuit 133 to generate/adjust the driving signal according to the compensation signal S33 and control the brightness of each pixel unit PX.

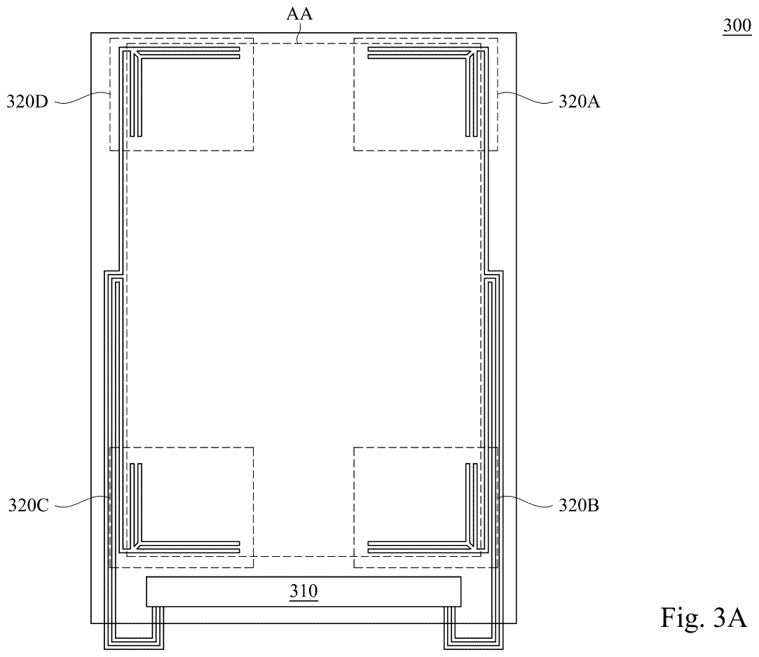

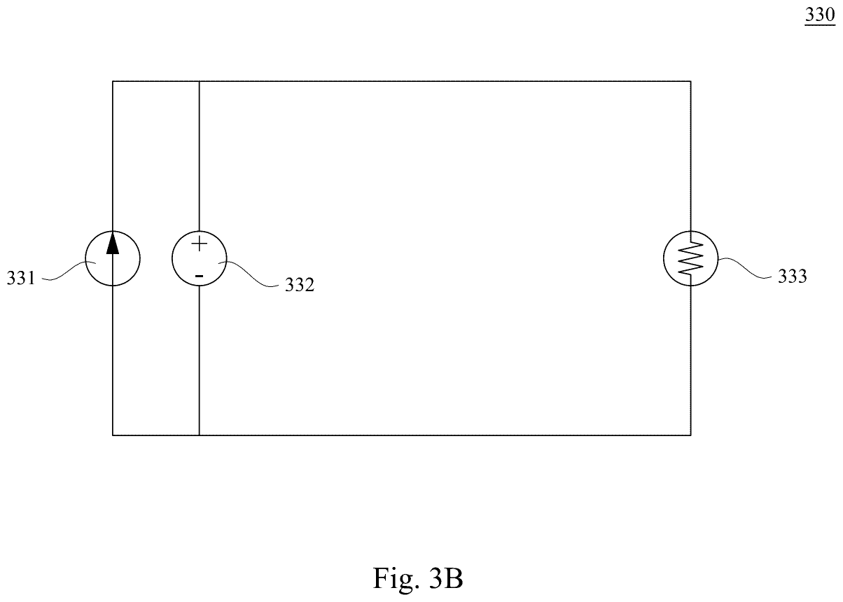

The following describes various embodiments of the sensing circuit and methods for determining the sensing impedance. FIG. 3A is a schematic diagram of a display panel 300 in some embodiments of the present disclosure, which can be implemented to the display panel 100 shown in FIG. 1. In order to simplify the diagram, FIG. 3A omits the display circuit and the conductive circuit, and only illustrates the display driver 310 and the sensing circuits 320A-320D in the conductive circuit. In addition, FIG. 3A illustrates the position of the active area AA to show the relative positions of the sensing circuits 320A-320D and the active area AA.

Referring to FIG. 3A, in this embodiment, the lengths of the sensing circuits 320A-320D are substantially the same, and the pattern structures are symmetrical to each other (e.g., bilateral symmetry). In other words, the lengths of each wire coupled to each of the sensing circuits 320A-320D and the display driver 310 are the same. Under the initial conditions of the same temperature, each of the sensing circuits 320A-320D has the same sensing impedances. Therefore, the display driver 310 does not need to calculate the “actual impedance value” of each of the sensing circuits 320A-320D, and can generate the corresponding compensation signal(s) by determining “the change of multiple sensing impedances” of the sensing circuits 320A-320D. For example, the display driver 310 may generate a compensation signal according to a change of the sensing impedance of the corresponding sensing circuit, or may generate a compensation signal according to multiple changes of the sensing impedances of multiple sensing circuits.

In some embodiments, the detection circuit (shown in FIG. 2) of the display driver 310 includes multiple detection units, each of the detection units is configured to detect the corresponding one of sensing circuits 320A-320D. FIG. 3B is a schematic diagram of one of the detection units 330 in some embodiments of the present disclosure, which is configured to detect the sensing impedance of the sensing circuit 333. The sensing circuit 333 can be implemented to one of the sensing circuits 122A-122D shown in FIG. 1, or one of the sensing circuits 320A-320D shown in FIG. 3A.

As shown in FIG. 3B, the detection unit 330 includes a current detector 331 and a voltage detector 332. The current detector 331 is connected in parallel to the corresponding sensing circuit 333, and is configured to provide a detection current. The voltage detector 332 is also connected in parallel to the corresponding sensing circuit 333 to detect the cross-voltage of the sensing circuit 333. According to the provided detection current and the detected cross-voltage, the display driver 310 can calculate the impedance value of the sensing circuit 333.

In the embodiments of FIGS. 3A and 3B, since the lengths of the sensing circuits 320A-320D are substantially the same, the impedance change of the sensing impedances of the sensing circuits 320A-320D will not differ due to the “difference in wire length”.

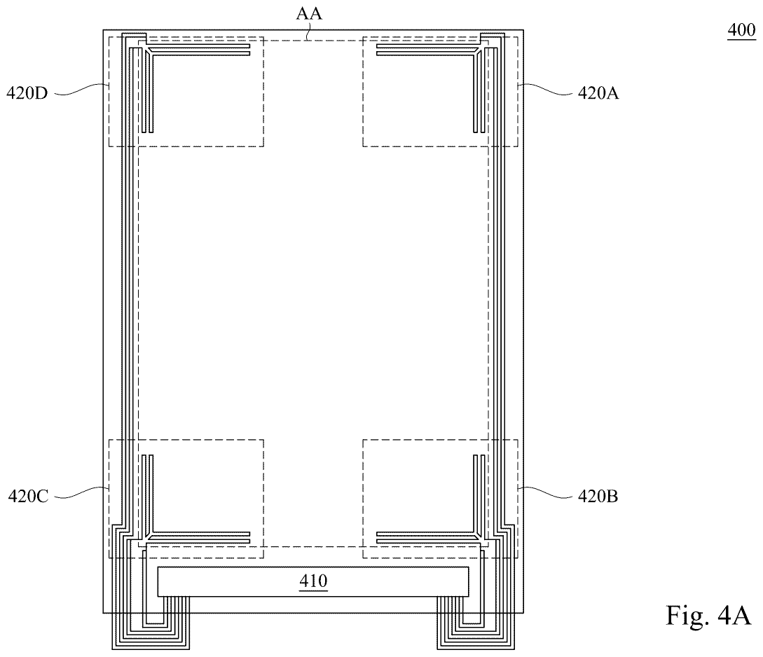

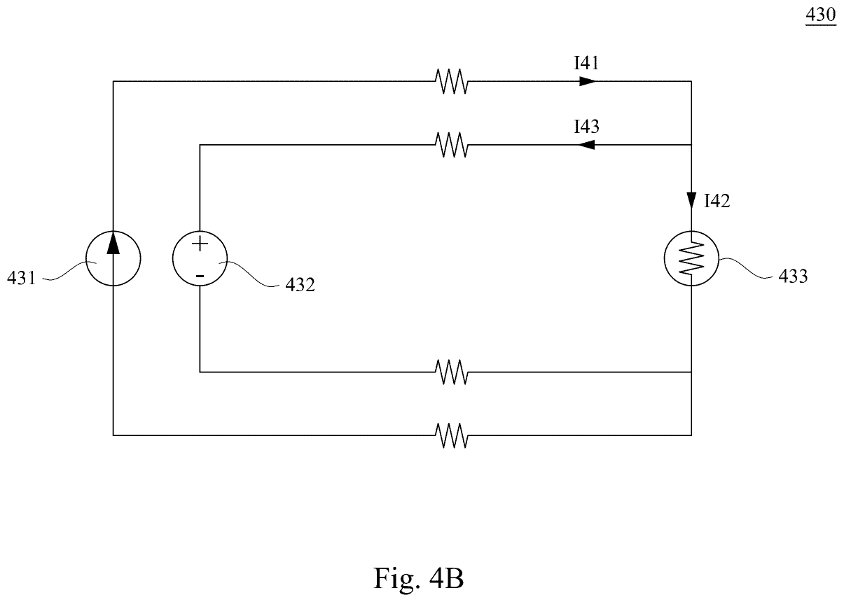

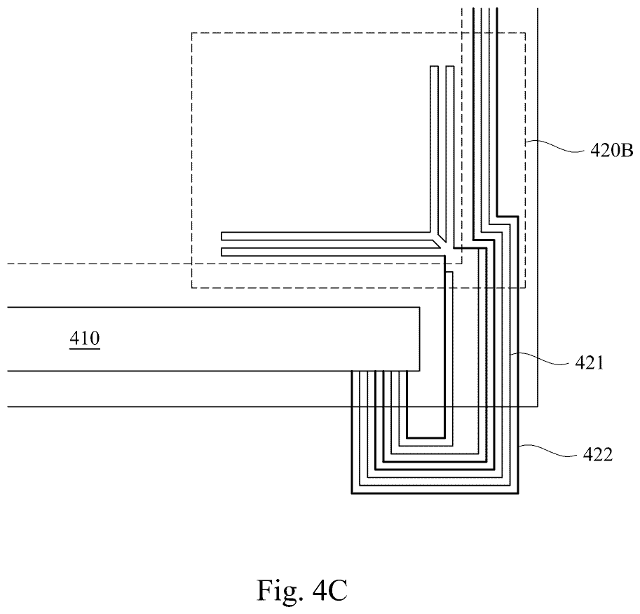

FIGS. 4A-4C are schematic diagrams of the display panel with different lengths of the sensing circuits. FIG. 4A is a schematic diagram of a display panel 100 in some embodiments of the present disclosure. FIG. 4B is a schematic diagram of a detection unit 400 n some embodiments of the present disclosure. FIG. 4C is a partial enlarged schematic diagram of the display panel 400 in some embodiments of the present disclosure. Similar to FIG. 3A, FIG. 4A omits the display circuit and the conductive circuit, and only illustrates the display driver 410 and the sensing circuits 420A-420D of the conductive circuit.

Referring to FIGS. 4A and 4B, since the lengths of each wire coupled to each of the sensing circuits 420A-420D and the display driver 410 are not the same, the sensing impedances detected by the detection unit 430 are affected by the wire lengths. For example, since the sensing circuit 420D is far away from the display driver 410, the wire impedance between the sensing circuit 420D and the display driver 410 may affect the detection result and may not correctly reflect the regional temperature of the active area.

As mentioned above, in order to detect the temperature of the region corresponding to the sensing circuit 420D, in this embodiment, the current detector 431 and the voltage detector 432 of the detection unit 430 are connected in parallel to the sensing circuit 433 through different loops, so that the display driver 410 can calculate the impedance value of the sensing circuit 433. The sensing circuit 433 may be any one of the sensing circuits 122A-122D shown in FIG. 1 or the sensing circuits 320A-320D shown in FIG. 3A.

As shown in FIG. 4B, the current detector 431 provides a current 141 through a first loop, and the voltage detector 432 detects the cross-voltage of the sensing circuit 433 through a second loop. Since the impedance of the voltage detector 432 is much greater than the impedance of the sensing circuit 433, the current 141 almost entirely flows through the sensing circuit 433. In other words, the current 143 will approach zero, and the current 142 will be equal to the current 141. Therefore, by connecting two different loops in parallel to the sensing circuit 433, the current and voltage of the sensing circuit 433 can be accurately obtained, and the impedance value of the sensing circuit 433 can be calculated without being affected by the impedance of other wires.

Referring to FIG. 4C, in one embodiment, the sensing circuit (take the sensing circuit 420B as an example) includes a low impedance path 421 and a high impedance path 422. The low impedance path 421 can be the first loop shown in FIG. 4B, which is configured to transmit current 141, that is, providing an inductive current. The high impedance path 422 can be the second loop shown in FIG. 4B, which is configured to detect voltage, so the current 142 is much smaller than current 141.

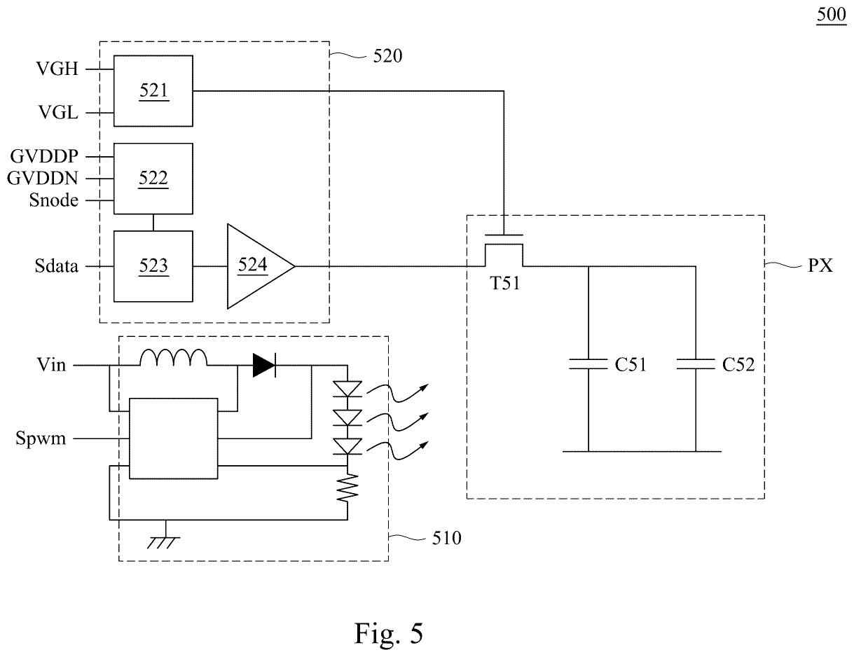

The display panel of the present disclosure can be applied to implement different types of display devices, such as an LCD panel or an OLED panel. FIG. 5 is a schematic diagram of a partial circuit of the display panel 500 in some embodiments of the present disclosure. As shown in FIG. 5, the display panel 500 is an LCD panel, and includes a backlight circuit 510, a driving circuit 520 and a pixel unit PX. The backlight circuit 510 controls the current provided th the backlight unit according to the input voltage Vin and the control signal Spwm, so as to control the backlight brightness.

The driving circuit 520 includes a gate driver 521, a gamma correction circuit 522, a digital-to-analog converter 523 and a source output circuit 524. The gate driver 521 (Gate Driver on Array, GOA) is configured to drive the gate of a transistor switch T51 in the transistor switch T51 according to the voltage signals VGH, VGL.

The gamma correction circuit 522 is configured to correct the display effect of the pixel unit PX (e.g., changes the gamma value or adjusts the gamma curve) according to the node signal Snode, the positive reference voltage GVDDP and the negative reference voltage GVDDN, so as to ensure that the image matches the expected color and the brightness.

The digital-to-analog converter 523 is configured to convert the data signal Sdata from digital format to analog format. The source output circuit 524 (Source Driver on Panel) is coupled to the digital-to-analog converter 523, is configured to control the cource of the transistor switch in the pixel unit PX, so as to provide the current required by the pixel unit PX. The voltage stored in the capacitors C51 and C52 of the pixel unit PX corresponds to the pixel value and/or the light transmittance.

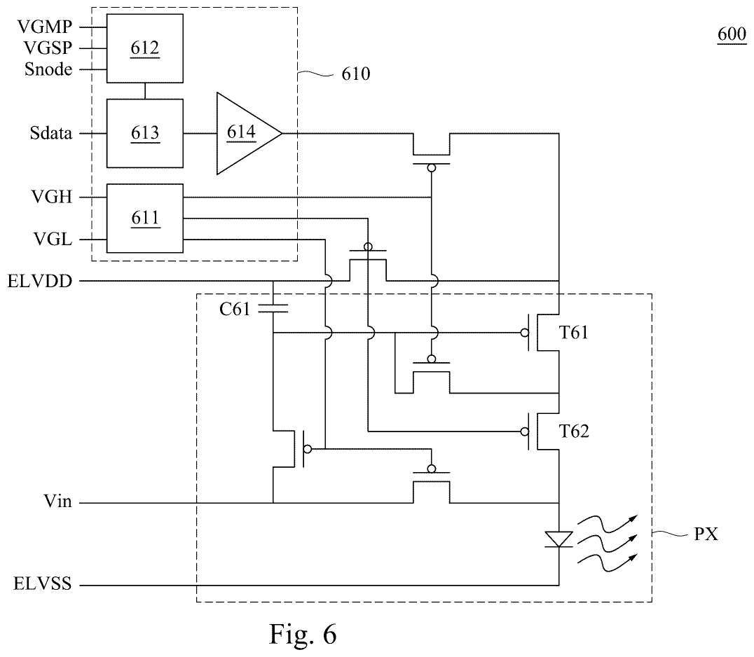

FIG. 6 is a schematic diagram of a partial circuit of a display panel 600 in some embodiments of the present disclosure. The display panel 600 includes a driving circuit 610 and a pixel unit PX. In this embodiment, the display panel is an OLED panel, and the brightness generated by the pixel circuit is determined by the input voltage Vin and the voltage signals ELVDD, ELVSS.

As shown in FIG. 6, the driving circuit 610 includes a gate driver 611, a gamma correction circuit 612, a digital-to-analog converter 613 and a source output circuit 614. The gate driver 611 is configured to drive the gate of the transistor switches T61, T62 in the pixel unit PX according to the voltage signals VGH, VGL, so as to control the current of the pixel unit PX.

The gamma correction circuit 612 is configured to correct the display effect of the pixel unit PX (e.g., changes the gamma value or adjusts the gamma curve) according to the node signal Snode, the positive reference voltage VGMP and the negative reference voltage VGSP, so as to ensure that the image matches the expected color and the brightness.

The digital-to-analog converter 613 is configured to convert the data signal Sdata from digital format to analog format. The source output circuit 614 is coupled to the digital-to-analog converter 613, and is configured to control the source of the transistor switch T61 in the pixel unit PX. The voltage stored in the capacitor C61 of the pixel unit PX corresponds to the pixel value.

According to the type of the display panel, the display driver can compensate in different methods. As mentioned above, “the compensation signal” can be the adjustment value of the driving signal in response to different temperatures, such as the gamma value, the pixel driving signal or the duty cycle of the backlight control signal. The gamma value can be determined by the node signal Snode, the positive reference voltages GVDDP/VGMP, or the negative reference voltages GVDDN/VGSP mentioned above. The pixel driving signal can be determined by the voltage signals VGH/VGL, the voltage signals ELVDD/ELVSS or the input voltage Vin. The duty cycle of the backlight control signal can be determined by the control signal Spwm mentioned above.

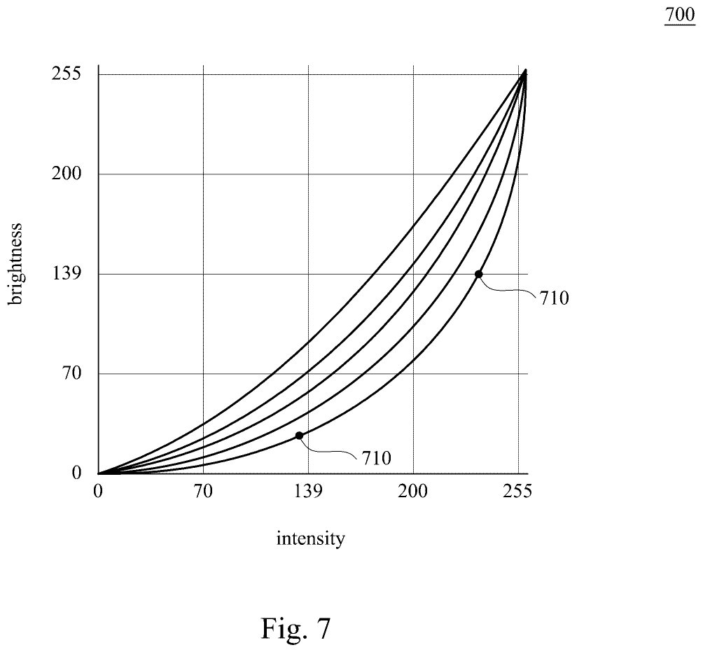

FIG. 7 is a schematic diagram of a gamma curve 700 in some embodiments of the present disclosure. The gamma curve 700 is configured to define the relationship between the intensity (e.g., pixel value) of the input signal and the brightness of the output signal. Different gamma curves correspond to different gamma values. In one embodiment, the display driver can adjust the gamma curve by changing the gamma value. In other embodiments, the display driver can adjust the gamma curve/gamma value by setting different gamma voltage nodes 710 (the position of the gamma voltage node 710 shown in FIG. 7 is only for illustration. The gamma voltage node 710 can be set to correspond to any intensity). The “gamma voltage node” is a reference voltage at a specific position in the gamma curve, which can be determined by the node signal Snode mentioned above. Therefore, by changing the position of the node signal Snode, the gamma curve/gamma value can be adjusted.

The elements, method steps, or technical features in the foregoing embodiments may be combined with each other, and are not limited to the order of the specification description or the order of the drawings in the present disclosure.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

1. A display panel, comprising:
a display circuit;
a conductive circuit configured to provide power to the display circuit;
a plurality of sensing circuits arranged at a plurality of positions in the display panel corresponding to the display circuit, wherein the plurality of sensing circuits and the conductive circuit are formed by a same material; and
a display driver coupled to the display circuit, the conductive circuit and the plurality of sensing circuits, and configured to detect a plurality of sensing impedances of the plurality of sensing circuits to generate a plurality of compensation signals, wherein the display driver is configured to control the display circuit according to the plurality of compensation signals;
wherein a plurality of lengths of the plurality of sensing circuits are substantially the same, and the display driver is configured to determine a change of the plurality of sensing impedances to generate the plurality of compensation signals.

2. The display panel of claim 1, wherein the plurality of sensing circuits are arranged at a plurality of positions in the display panel corresponding to an edge of the display circuit.

3. The display panel of claim 2, wherein at least one part of each of the plurality of sensing circuits is arranged in an active area of the display panel.

4. The display panel of claim 3, wherein the at least one part of each of the plurality of sensing circuits comprises a L-shaped pattern structure.

5. (canceled)

6. (canceled)

7. The display panel of claim 1, wherein a plurality of pattern structures of the plurality of sensing circuits are symmetrical to each other.

8. The display panel of claim 1, wherein the display driver comprises a current detector and a voltage detector, the current detector and the voltage detector are connected in parallel to one of the plurality of sensing circuits through different loops, so that the display driver calculates a impedance value of the one of the plurality of sensing circuits.

9. The display panel of claim 1, wherein the display driver is configured to adjust a gamma value, a pixel driving signal or a duty cycle of a backlight control signal according to the plurality of compensation signals.

10. The display panel of claim 1, wherein the conductive circuit and the plurality of sensing circuits are formed by Indium Tin Oxide.

11. A display driver, comprising:
a detection circuit coupled to a plurality of sensing circuits of a display panel, and configured to detect a plurality of sensing impedances of the plurality of sensing circuits, wherein the plurality of sensing circuits and a conductive circuit of the display panel are formed by a same material, and the conductive circuit is configured to provide power to a display circuit of the display panel;
a conversion circuit coupled to the detection circuit, and configured to calculate a plurality of detected temperature values according to the plurality of sensing impedances; and
a compensation circuit coupled to the conversion circuit and the display circuit, and configured to generate a plurality of compensation signals according to the plurality of detected temperature values, so as to control the display circuit according to the plurality of compensation signals;
wherein a plurality of lengths of the plurality of sensing circuits are substantially the same, and the detection circuit is configured to determine a change of the plurality of sensing impedances to generate the plurality of compensation signals.

12. The display driver of claim 11, wherein the plurality of sensing circuits are arranged at a plurality of positions in the display panel corresponding to an edge of the display circuit.

13. The display driver of claim 12, wherein at least one part of each of the plurality of sensing circuits is arranged in an active area of the display panel.

14. The display driver of claim 13, wherein the at least one part of each of the plurality of sensing circuits comprises a L-shaped pattern structure.

15. (canceled)

16. (canceled)

17. The display driver of claim 11, wherein a plurality of pattern structures of the plurality of sensing circuits are symmetrical to each other.

18. The display driver of claim 11, wherein the detection circuit comprises a current detector and a voltage detector, the current detector and the voltage detector are connected in parallel to one of the plurality of sensing circuits through different loops, so that the detection circuit calculates a impedance value of the one of the plurality of sensing circuits.

19. The display driver of claim 11, wherein the display driver is configured to adjust a gamma value, a pixel driving signal or a duty cycle of a backlight control signal according to the plurality of compensation signals.

20. The display driver of claim 11, wherein the conductive circuit and the plurality of sensing circuits are formed by Indium Tin Oxide.
